(19) United States
(12) Patent Application Publication
(10) Pub. No.: US 2008/0284545 A1
(43) Pub. Date: Nov. 20, 2008

(54) FIXED IMPEDANCE LOW PASS METAL POWDER FILTER WITH A PLANAR BURIED STRIPLINE GEOMETRY

(76) Inventors: George Andrew Keefe, Cortlandt Manor, NY (US); Roger Hilsen Koch, Amawalk, NY (US); Frank P. Milliken, JR., Tarrytown, NY (US); James R. Rozen, Peekskill, NY (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/748,628

(22) Filed: May 15, 2007

(51) Int. Cl. H01P 1/203

(52) U.S. Cl. 333/204

(57) ABSTRACT

A fixed impedance low pass metal powder filter having a planar buried stripline geometry comprises first and second parallel ground planes spaced from one another and a central stripline spaced equal distance from the first and second parallel ground planes and parallel thereto. The space between the first and second ground planes is filled with a dielectric containing metal powder. The densities of the metal powder within the dielectric are highest near the central stripline and become less near the first and second ground planes. The dielectric is a laminated structure that comprises layers of epoxy impregnated fiberglass, layers having different densities of metal powder.

### CROSS-REFERENCE TO RELATED APPLICATION

The subject matter of this application is related to the disclosure of co-pending application Ser. No. 11/456,351 of Milliken et al., the inventors in this application, for “50Ω Characteristic Impedance Low Pass Metal Powder Filters”, filed Jul. 10, 2006 (IBM Docket YOR920060147US1), the disclosure of which is incorporated herein by reference.

### DESCRIPTION

### Background of the Invention

1. Field of the Invention

The present application generally relates to quantum computation and, more particularly, to fixed impedance low pass metal powder filters used to measure qubits. The low pass metal powder filters according to the invention are a planar design which is scalable and integratable, allowing the measurement of many side by side coupled qubits.

2. Background Description

A qubit is a quantum bit, the counterpart in quantum computing to a binary bit, representing Boolean states “1” and “0”, in classical digital computing. Quantum computing is computation on the atomic scale. Quantum mechanical tunneling is how a bit changes its state. One of the practical problems to a physically realizable quantum computer is the need for some scheme to combat the effects of decoherence. Ideally, one or more qubits exchange information and/or compute in a “quiet”, noise-free environment at very low temperatures. However, in order to read out the quantum states of the qubits, one must connect room temperature electronics to the qubits. These electronics are a source of noise that can cause the qubits to change states erroneously. This process is called decoherence.

Decoherence in superconducting qubits is often caused by high frequency noise transmitted along electrical leads connecting the qubit, which is at a temperature below 4° Kelvin (K), to measurement electronics at room temperature. The noise can come directly from the measurement electronics, or it can also be generated by resistive elements in the cold space at temperatures warmer than the temperature of the qubit. The easiest way to solve this problem is to add one or more low pass filters to the wiring in the cold space. However, until recently, there were no commercially available filters which work at frequencies above 1 gigaHertz (GHz) and temperatures near 4° K. For this reason, most researchers have been forced to design and make their own. The most popular filter design is the metal powder filter. The standard metal powder or metal powder/epoxy filter has a center conductor that is surrounded by metal powder or metal powder/epoxy mixture. The filter attenuates an incoming electrical signal via eddy current dissipation in the metal powder. In all cases, the center conductor is shaped into the form of a spiral to increase attenuation. The spiral plus metal powder is located inside a metal tube or metal box and electrical connectors are attached. This design works very reliably at low temperatures.

In our qubit experiments, it is necessary that the characteristic impedance of the entire measurement setup be 50 ohms (Ω) everywhere. The metal powder filter described above is not 50Ω. A simple time domain reflectometer (TDR) measurement on a metal powder filter with a helical center conductor shows instead that the impedance is much larger than 50Ω. There are two known solutions to this problem. One solution is that one can now buy commercial low pass filters that attenuate in the GHz range. The cutoff frequency (f_{c}) can be specified and the filter exhibits significant attenuation above the cutoff frequency. However, even though the average impedance is indeed near 50Ω, the impedance indicated by a TDR measurement is not very flat and shows deviations as large as plus or minus 30Ω. This variation is often unacceptable.

The second solution is the “bulky” low pass metal powder filter disclosed in our co-pending application Ser. No. 11/456,351. The geometry of the bulky metal powder filter is similar to the standard coaxial geometry. The center conductor is a straight wire and the tube is filled with a metal powder/epoxy mixture. The type and percentage of metal powder determines the attenuation (A) and the impedance (Z). The cutoff frequency (f_{c}) is determined by the average diameter of the metal powder particles.

The implementation of the bulky metal powder filter is not simple. One must address the following issues: thermal heat sinking of the metal conductor, differential thermal contraction between the metal parts and the metal power/epoxy mixture, and centering the center conductor everywhere inside the metal tube. In our prior invention disclosed in our co-pending application Ser. No. 11/456,351, we have solved these issues and the resulting filter works very well at low temperatures. However, the difficult to make bulky metal powder filter is intrinsically not scaleable nor is it integratable. If we want to measure many side by side coupled qubits, this design cannot be used. The commercial filters are also imminently not scalable.

### SUMMARY OF THE INVENTION

It is therefore an object of the present invention to provide a way to easily fabricate fixed characteristic impedance low pass metal powder filters with a cutoff frequency f_{c} near 1 GHz, which work well at low temperatures and are scalable and integrable.

To solve our problem, we need to change the overall geometry of our filter. According to the present invention, we have adopted a planar design. By doing this, we are able to draw upon many of the techniques used to make printed circuit boards. More specifically, the geometry is that of a buried stripline where the dielectric material between the conducting layers are made using a new composite matrix that is impregnated with metal powder. In the preferred embodiment of the invention, the composite matrix is composed of dielectric layers having different amounts of metal powder. The entire stackup typically occurs in the following order: copper (Cu) ground plane, fiberglass/epoxy laminate board with a low percentage of metal powder, fiberglass/epoxy laminate board with a high percentage of metal powder, copper buried stripline, fiberglass/epoxy laminate board with a high percentage of metal powder, fiberglass/epoxy laminate board with a low percentage of metal powder, and a copper ground plane. This new design is easily scaleable and integratable. In qubit applications, we want to maximize the attenuation and therefore we want to have a high percentage of metal powder near the stripline. For practical reasons (brittleness of the overall structure), we do not use a high percentage of metal powder everywhere.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a cross-sectional view of the new low pass metal powder filter according to the present invention;

FIG. 2 is an isometric partial cut away view of the new low pass metal powder filter according to the present invention; and

FIG. 3 is an isometric view of a low pass metal powder filter integrated into a printed circuit board.

### DETAILED DESCRIPTION OF A PREFERRED EMBODIMENT OF THE INVENTION

In our qubit experiments, one or more electrical lines transmit very fast shaped pulses. The measurements setup is designed to be 50Ω everywhere since any impedance mismatches will affect the shaped pulse. The room temperature electronics are a source of noise, and therefore these fast lines include metal powder filters located at low temperatures. The filters are designed to have a 50Ω characteristic impedance.

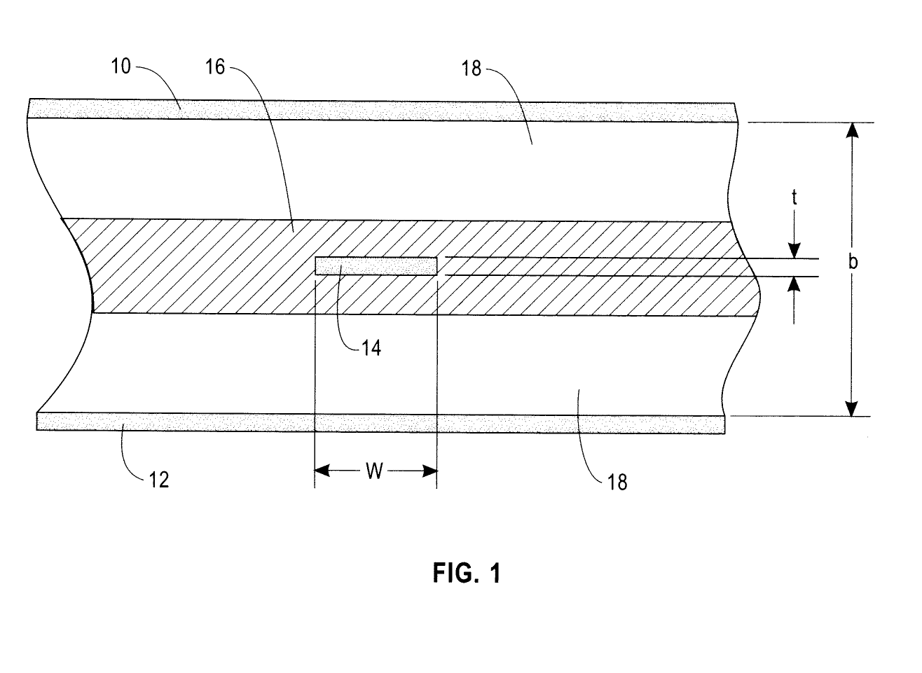

Referring now to the drawings, and more particularly to FIG. 1, there is illustrated a cross-sectional view of the new low pass metal powder filter according to the present invention. Layers 10 and 12 are copper ground planes, and the middle copper line 14 is the buried stripline. The regions in between the ground planes 10 and 12 and the buried stripline 14 are dielectric material. The region 16 in the vicinity of the stripline 14 is a region of composite matrix with a high percentage of metal powder. In the preferred embodiment of the invention, the metal powder is bronze, but other metals may be used depending on the required attenuation characteristics. The regions 18 between the region 16 and the ground planes 10 and 12 are regions of low density metal powder in a composite matrix. In a preferred embodiment, the metal powder is bronze powder and the matrix is fiberglass and epoxy. To maximize the attenuation of unwanted “noise” on the stripline, the amount of metal powder near the stripline, in the region 16, must be high. Away from the stripline 14, in the regions 18, the amount of metal powder can be less. Given t, the thickness of the stripline 14, b, the distance between the ground planes 10 and 12, w, the width of the stripline 14, and the effective dielectric constant ∈, one can calculate the impedance of the filter. For example, one can use the formulas below which appear on page 34 in the book Stripline Circuit Design by Harlan Howe, Jr. The value of the dielectric constant ∈ is determined by the particular implementation and must be measured experimentally.

$${Z}_{0} \sqrt{ɛ} = 60 {log}_{e} ( \frac{4 b}{π d} )$$

$$d = \frac{w}{2} [ 1 + \frac{t}{π w} ( 1 + {log}_{e} \frac{4 π w}{t} + .51 {π ( \frac{t}{w} )}^{2} ) ]$$

These equations show that the impedance Z₀ can be tailored by adjusting the geometrical parameters w, t and b or by adjusting the dielectric constant ∈. Often the geometrical parameters are fixed by the application and therefore we must adjust Z₀ by adjusting ∈. In our application, we can adjust ∈ by varying the type of metal powder, the particle diameter, and the percentage (by weight) of metal powder in the composite matrix.

There are many technical details that must be considered with the new design. First, one must make the metal powder impregnated circuit boards. The amount of metal powder that can be added to the epoxy that is then injected into the fiberglass weave must be determined experimentally. If the amount of metal powder becomes too high, the board may become too brittle. For this reason, we have chosen to make the filter using several dielectric sheets that are laminated together. The sheets next to the stripline 14 are thin and have a high percentage of metal powder, while other sheets with less powder are added to give the desired thickness b. This provides a more robust structure.

Another detail that needs to be addressed is which epoxy to use. In the bulky low pass metal powder filter described in our co-pending application Ser. No. 11/456,351, we used Stycast 2850 FT epoxy made by Emerson & Cuming. At low temperatures, we found that this epoxy better matched the differential thermal contraction of the metal parts of the filter. When we used other epoxies, the center wire would sometimes break upon cooling to low temperatures. However, the new planar geometry should be more forgiving. In any case, the epoxy should be chosen to closely match the thermal contraction of the copper. Another factor in choosing the epoxy is that the epoxy needs to be a reasonably good thermal conductor so that the buried stripline is well thermalized.

The final detail is the kind of connectors to use. We have chosen surface mount SSMA connectors, which are a standard high frequency connector. The main advantage of this kind of connector is that cross talk between connectors can be reduced significantly.

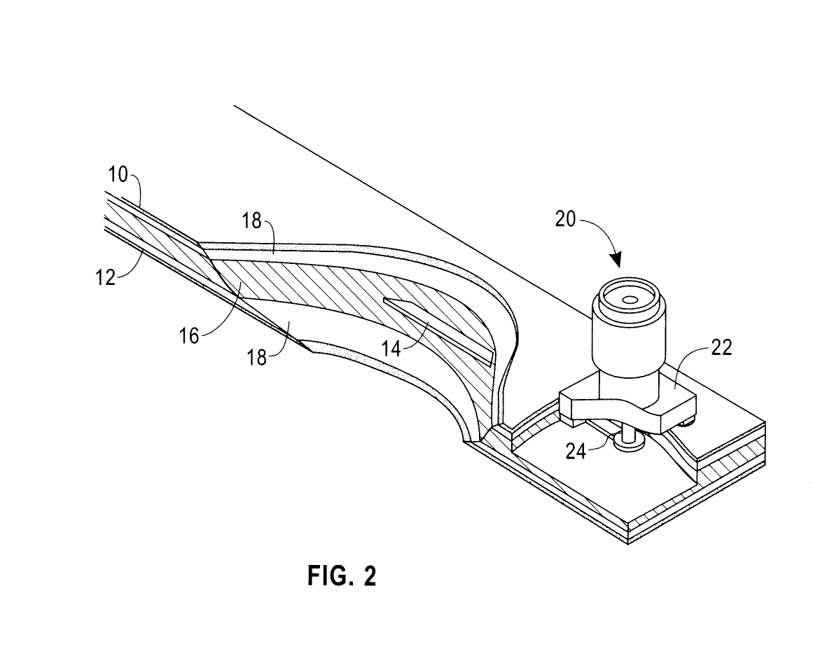

FIG. 2 is an isometric view in partial cross-section showing one of the metal powder low pass filters according to the invention. The reference numerals in this figure denote the same or corresponding elements illustrated in the cross-sectional view of FIG. 1. In FIG. 2, the embedded stripline or conductor 14 can be seen in the region 16 of high density metal powder loaded board material. The lower density metal powder composite board material regions 18 fill the spaces between the region 16 and the ground planes 10 and 12. A surface mount SSMA connector 20 has its outer conductor 22 mounted to ground plane 10 and its central conductor 24 connected to the embedded stripline 14.

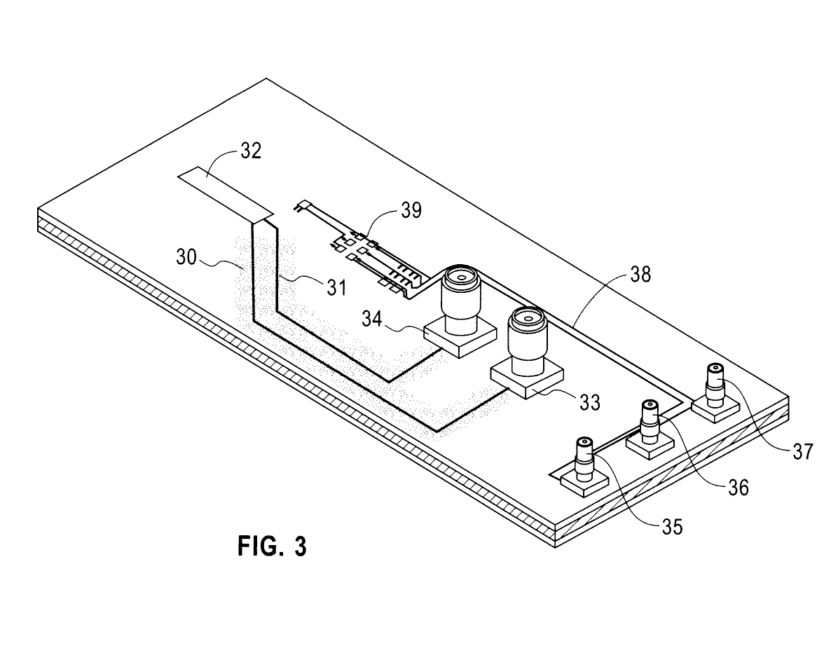

FIG. 3 illustrates a printed circuit board incorporating two low pass metal powder filters 30 and 31 extending between a silicon qubit chip 32 and respective surface mount connectors 33 and 34. This printed circuit board also illustratively includes three low speed connectors 35, 36 and 37 with connections 38 extending to unfiltered surface conductors 39. This illustration is for the purpose of demonstrating the scalable and integratable features of the present invention.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A fixed impedance low pass metal powder filter having a planar buried stripline geometry comprising:
first and second parallel ground planes spaced from one another;
a central stripline spaced equal distance from the first and second parallel ground planes and parallel thereto; and
a dielectric containing metal powder filling a space between the first and second ground planes.

2. The fixed impedance low pass metal powder filter of claim 1, wherein densities of the metal powder within the dielectric are highest near the central stripline and less near the first and second ground planes.

3. The fixed impedance low pass metal powder filter of claim 2, wherein the metal powder is bronze.

4. The fixed impedance low pass metal powder filter of claim 2, wherein the dielectric is formed as a laminated structure.

5. The fixed impedance lows pass metal powder filter of claim 4, wherein the laminated structure comprises layers of epoxy impregnated fiberglass, layers having different densities of metal powder.

6. The fixed impedance low pass metal powder filter of claim 5, wherein the metal powder is bronze.

7. The fixed impedance low pass metal powder filter of claim 2, further comprising a surface mount electrical connector mounted on one of said first and second ground planes and having a central conductor extending through said dielectric and electrically connected to said central stripline.

8. The fixed impedance low pass metal powder filter of claim 7, wherein the dielectric is formed as a laminated structure.

9. The fixed impedance lows pass metal powder filter of claim 8, wherein the laminated structure comprises layers of epoxy impregnated fiberglass, layers having a different densities of metal powder.

10. The fixed impedance low pass metal powder filter of claim 9, wherein the metal powder is bronze.

11. A printed circuit board for making connections to one or more quantum bit (qubit) chips in a quantum computer comprising:
one or more fixed impedance low pass metal powder filters, each low pass metal powder filter comprising first and second parallel ground planes spaced from one another, a central stripline spaced equal distance from the first and second parallel ground planes and parallel thereto, a dielectric containing metal powder filling space between the first and second ground planes, and a surface mount electrical connector mounted on one of said first and second ground planes and having a central conductor extending through said dielectric and electrically connected to said central stripline; and
one or more qubit chips mounted on said printed circuit board, connections to the qubit chips being made by said central striplines of said one or more fixed impedance low pass metal powder filters.

12. The printed circuit board of claim 11, wherein densities of the metal powder within the dielectric are highest near the central stripline and less near the first and second ground planes

13. The printed circuit board of claim 12, wherein the dielectric of said one or more fixed impedance low pass metal powder filters is formed as a laminated structure.

14. The printed circuit board of claim 13, wherein the laminated structure comprises layers of epoxy impregnated fiberglass, layers having different densities of metal powder.

15. The printed circuit board of claim 14, wherein the metal powder is bronze.

16. The printed circuit board of claim 15, further comprising low speed connectors making unfiltered connections of other components mounted on the printed circuit board.
